(19) United States
(12) Patent Application Publication
(10) Pub. No.: US 2013/0002390 A1
(43) Pub. Date: Jan. 3, 2013

(54) TRANSFORMER AND DISPLAY DEVICE USING THE SAME

(75) Inventors: Ki Hung NAM, Suwon (KR); Jae Gen EOM, Hwaseong (KR); Soon Young KWON, Suwon (KR)

(73) Assignee: SAMSUNG ELECTRO-MECHANICS CO., LTD.

(21) Appl. No.: 13/331,829

(22) Filed: Dec. 20, 2011

(30) Foreign Application Priority Data
Jun. 30, 2011 (KR) 10-2011-0065114

(51) Int. Cl. H01F 27/30; H01F 27/28

(52) U.S. Cl. 336/207; 336/220

(57) ABSTRACT

There are provided a transformer capable of being easily manufactured by facilitating insulation between coils and minimizing leakage inductance, and a display device using the same. The transformer includes: a bobbin including at least one partition wall formed on an outer peripheral surface of a body part having a pipe; a coil group including a plurality of coils wound while being stacked on the body part and at least one insulating wire wound between the plurality of coils; and a core electromagnetically coupled to the coils to thereby form a magnetic path, wherein the plurality of coils are individually wound so as to be uniformly disposed in a plurality of spaces partitioned by the at least one partition wall.

### CROSS-REFERENCE TO RELATED APPLICATIONS

This application claims the priority of Korean Patent Application No. 10-2011-0065114 filed on Jun. 30, 2011, in the Korean Intellectual Property Office, the disclosure of which is incorporated herein by reference.

### BACKGROUND OF THE INVENTION

1. Field of the Invention

The present invention relates to a transformer capable of being easily manufactured by facilitating insulation between coils and minimizing leakage inductance, and a display device using the same.

2. Description of the Related Art

Various kinds of power supplies are required in various electronic devices such as a television (TV), a monitor, a personal computer (PC), an office automation (OA) device, and the like. Therefore, these electronic devices generally include power supplies converting alternating current (AC) power supplied from the outside into a power required for each type of electronic appliance.

Among power supplies, a power supply using a switching mode (for example, a switch mode power supply (SMPS)) has recently been mainly used. This SMPS basically includes a switching transformer.

A switching transformer generally converts AC power of 85 to 265 V into direct current (DC) power of 3 to 30 V through high frequency oscillation at 25 to 100 KHz. Therefore, in a switching transformer, the sizes of a core and a bobbin may be significantly reduced as compared to a general transformer converting AC power of 85 to 265 V into an AC current of 3 to 30 V through frequency oscillation of 50 to 60 Hz, and low voltage, low current DC power may be stably supplied to an electronic appliance. Accordingly, a switching transformer has recently been widely used in an electronic appliance that has tended to be miniaturized.

In order to satisfy a safety standard of this switching transformer, insulating tape is wound between coils to thereby secure electrical insulation therebetween. In accordance with miniaturization of the switching transformer, the insulating tape must be directly manually wound by a person, such that manufacturing costs increase.

In addition, the switching transformer needs to be designed to have low leakage inductance in order to increase energy conversion efficiency. However, in accordance with the miniaturization of the switching transformer, it may be difficult to design a switching transformer having a small leakage inductance.

### SUMMARY OF THE INVENTION

An aspect of the present invention provides a compact switching transformer and a display device using the same.

Another aspect of the present invention provides a transformer having reduced manufacturing costs by securing insulation between coils through an automated process, and a display device using the same. Still another aspect of the present invention provides a transformer capable of minimizing leakage inductance, and a display device using the same.

According to an aspect of the present invention, there is provided a transformer including: a bobbin including at least one partition wall formed on an outer peripheral surface of a body part having a pipe; a coil group including a plurality of coils wound while being stacked on the body part and at least one insulating wire wound between the plurality of coils; and a core electromagnetically coupled to the coils to thereby form a magnetic path, wherein the plurality of coils are individually wound so as to be uniformly disposed in a plurality of spaces partitioned by the at least one partition wall.

The at least one partition wall may include at least one skip groove formed therein, and the plurality of coils may be wound while skipping the at least one partition wall via the skip groove.

The at least one skip groove may be formed by cutting away a portion of the at least one partition wall such that the outer peripheral surface of the body part is exposed.

All of the plurality of partitioned spaces of the bobbin may be formed to have the same size.

The bobbin may include a flange part extended from both ends thereof in an outer diameter direction of the body part.

The flange part may include at least one insulating rib protruding from an outer surface thereof in order to reinforce rigidity thereof.

The at least one insulating rib may protrude corresponding to a shape of the core and at a height corresponding to a creepage distance between the core and the plurality of coils.

The bobbin may include a terminal connection part extended from either end of the body part in an outer diameter direction of the body part, and including a plurality of external connection terminals connected to a distal end thereof.

The terminal connection part may include at least one lead groove formed therein, and at least one of the plurality of coils may have a lead wire leading to the outside of the bobbin through the at least one lead groove.

The at least one lead groove may be formed by cutting away a portion of the terminal connection part such that the outer peripheral surface of the body part is exposed.

The terminal connection part may include an extension groove formed in such a manner that the at least one lead groove has an extended width at a portion thereof adjacent to the body part.

The plurality of coils may have lead wires disposed in an altered direction while supporting a sidewall of the extension groove.

The extension groove may have a chamfered edge portion.

The terminal connection part may include at least one guide protrusion protruding from at least one surface thereof, the at least one guide protrusion guiding lead wires of the plurality of coils to the plurality of external connection terminals.

The terminal connection part may include at least one guide groove formed in at least one surface thereof, the at least one guide groove guiding lead wires of the plurality of coils to the plurality of external connection terminals.

The plurality of coils may include a plurality of primary coils and a plurality of secondary coils.

The plurality of coils may be wound while being stacked such that the plurality of secondary coils are interposed between the plurality of primary coils, and the at least one insulating wire may be wound between the plurality of primary coils and between the plurality of secondary coils.

The plurality of primary coils may be multi-insulated coils.

At least one of the plurality of coils may be a multi-insulated coil.

The multi-insulated coil may be disposed at at least one of an innermost position or an outermost position of the plurality of the coils wound while being stacked in a winding part.

According to another aspect of the present invention, there is provided a transformer including: a bobbin including a plurality of partitioned spaces; and a coil group including a plurality of coils wound while being stacked in the plurality of partitioned spaces and at least one insulating wire wound between the plurality of coils; wherein the plurality of coils are individually wound so as to be uniformly disposed in the plurality of partitioned spaces.

According to another aspect of the present invention, there is provided a display device including: a switching mode power supply including at least one transformer of any one of claims 1 to 21 mounted on a substrate thereof; a display panel receiving a power from the switching mode power supply; and covers protecting the display panel and the switching mode power supply.

The coil group of the transformer may be wound so as to be parallel to the substrate of the switching mode power supply.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a transformer according to an embodiment of the present invention;

FIG. 2A is a perspective view schematically showing a bobbin of the transformer shown in FIG. 1;

FIG. 2B is a perspective view schematically showing a lower surface of the bobbin shown in FIG. 2A;

FIG. 3 is a plan view schematically showing the bobbin of FIGS. 2A and 2B;

FIG. 4 is a cross-sectional view taken along line A-A′ of FIG. 3;

FIG. 5 is a partial cross-sectional view taken along line B-B′ of FIG. 3;

FIG. 6 is a partial cross-sectional view taken along line A-A′ of FIG. 3;

FIGS. 7A through 7E are views describing a method of winding coils shown in FIG. 5;

FIG. 8 is a perspective view showing a transformer according to another embodiment of the present invention;

FIG. 9 is a perspective view showing a transformer according to another embodiment of the present invention;

FIGS. 10A and 10B are perspective views showing a side of the transformer shown in FIG. 9;

FIG. 11 is a perspective view schematically showing a lower surface of a bobbin shown in FIG. 9; and

FIG. 12 is an exploded perspective view schematically showing a flat panel display device according to an embodiment of the present invention.

### DETAILED DESCRIPTION OF THE PREFERRED EMBODIMENT

Embodiments of the present invention will now be described in detail with reference to the accompanying drawings.

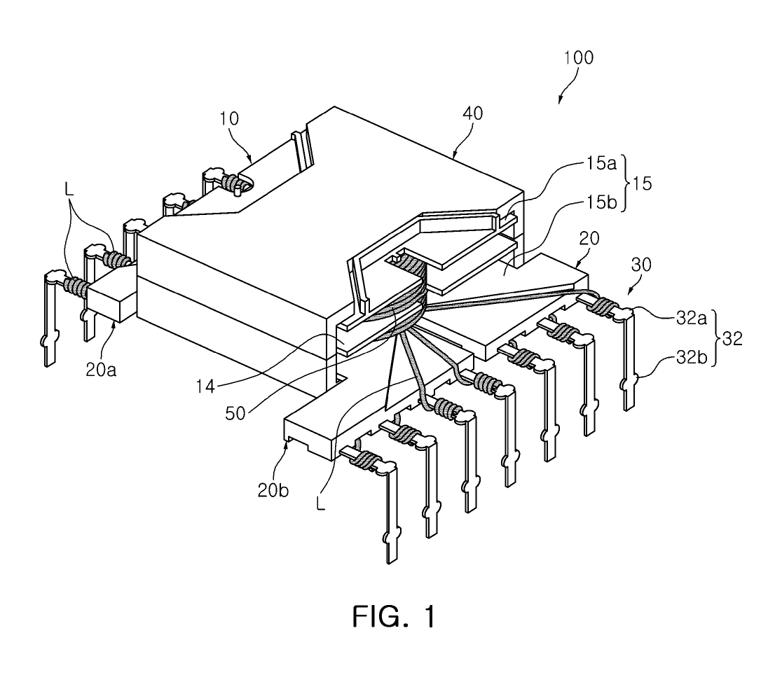

FIG. 1 is a perspective view schematically showing a transformer according to an embodiment of the present invention.

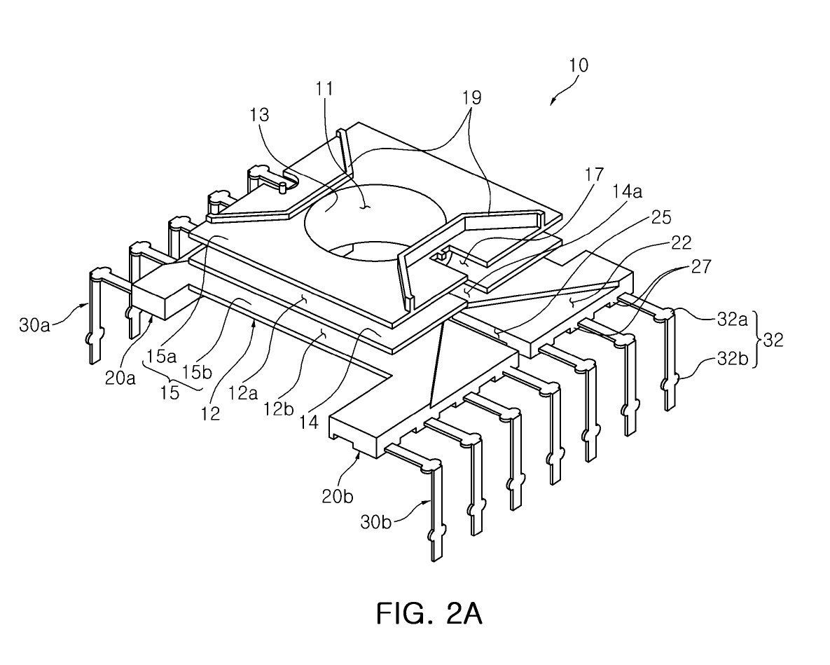

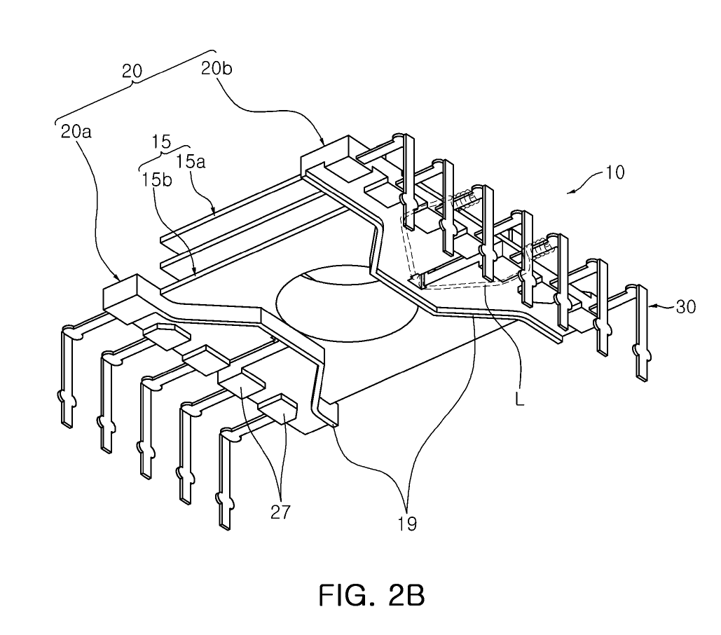

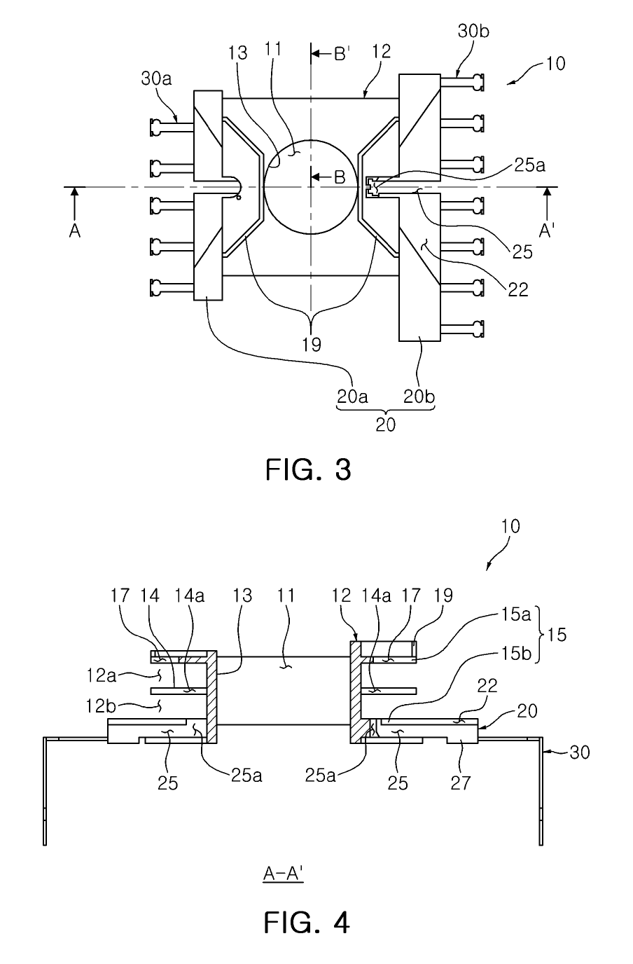

FIG. 2A is a perspective view schematically showing a bobbin of the transformer shown in FIG. 1, and FIG. 2B is a perspective view schematically showing a lower surface of the bobbin shown in FIG. 2A. FIG. 3 is a plan view schematically showing the bobbin of FIGS. 2A and 2B. FIG. 4 is a cross-sectional view taken along line A-A′ of FIG. 3.

Referring to FIGS. 1 through 4, a transformer 100 according to an embodiment of the present invention, an insulating type switching transformer, includes a bobbin 10, a core 40, and a coil group 50.

The bobbin 10 includes a winding part 12 having the coil group 50 wound therein and a terminal connection part 20 formed at one end of the winding part 12.

The winding part 12 may include a body part 13 having a pipe shape and a flange part 15 extended from both ends of the body part 13 in an outer diameter direction thereof.

The body part 13 may include a through hole 11 formed in an inner portion thereof and at least one partition wall 14 formed on an outer peripheral surface thereof, the through hole 11 having the core 40 partially inserted thereinto and the partition wall 14 partitioning a space in a length direction of the body part 13. In this configuration, each of the spaces partitioned by the partition wall 14 may include the coil group 50 wound therein.

The winding part 12 according to the embodiment of the present invention includes a single partition wall 14. Therefore, the winding part 12 according to the embodiment of the present invention may include two partitioned spaces 12a and 12b. However, the present invention is not limited thereto. Various numbers of spaces maybe formed and used through various numbers of partition walls 14 as needed.

In addition, the partition wall 14 according to the embodiment of the present invention may includes at least one skip groove 14a formed therein such that the coil group 50 wound in a specific space 12a (hereinafter, referred to as an upper space) may skip the partition wall 14 to thereby be wound in another space 12b (hereinafter, referred to as a lower space) adjacent to the specific space.

The skip groove 14a may be formed to have a shape in which a portion of the partition wall 14 is completely cut away such that an outer surface of the body part 13 is exposed. In addition, the skip groove 14a may have a width wider than a thickness (that is, a diameter) of the coil group 50. The skip groove 14a may be formed in pair corresponding to a position of the terminal connection part 20 to be described below.

The partition wall 14 according to the embodiment of the present invention is provided in order to uniformly dispose and allow the coil group 50 to be wound in the partitioned spaces 12a and 12b. Therefore, the partition wall may have various thicknesses and be made of various materials as long as a form thereof may be maintained.

Meanwhile, although the embodiment of the present invention describes a case in which the partition wall 14 is formed integrally with the bobbin 10 by way of example, the present invention is not limited thereto and may be variously applied. For example, the partition wall 14 may also be formed as an independent separate member and be then coupled to the bobbin 10.

The partition wall 14 according to the embodiment of the present invention may have the approximately same shape as that of the flange part 15.

The flange part 15 protrudes in such a manner as to extend from both ends, that is, upper and lower ends, of the body part 13 in an outer diameter direction thereof. The flange part 15 according to the embodiment of the present invention maybe divided into an upper flange part 15a and a lower flange part 15b according to a formation position thereof.

In addition, spaces between the outer peripheral surface of the body part 13 and the upper and lower flange parts 15a and 15b are formed as the spaces 12a and 12b in which the coil group 50 is wound. Therefore, the flange part 15 may serve to protect the coil group 50 from the outside and secure insulation between the coil group 50 and the outside, while simultaneously serving to support the coil group 50 wound in the winding spaces 12a and 12b at both sides thereof.

Meanwhile, in order to form the transformer 100 having a reduced thickness, the flange part 15 of the bobbin 10 may be formed to have a maximally reduced thickness. However, in a case in which the bobbin 10 is made of a resin material which is an insulating material, when the flange part 15 has an excessively reduced thickness, the flange part 15 does not maintain its shape and may be bent.

Therefore, the bobbin 10 according to the embodiment of the present invention may include insulating ribs 19 formed on an outer surface of the flange part 15 in order to prevent the flange part 15 from being bent and reinforce rigidity of the flange part 15.

The insulating ribs 19 may be formed on both of outer surfaces of the two flange parts 15a and 15b, or selectively formed on any one thereof as needed.

The embodiment of the present invention describes a case in which the respective insulating ribs 19 are formed on the outer surfaces of the upper and lower flange parts 15a and 15b by way of example. Here, the insulating ribs 19 may protrude to have a shape corresponding to that of the core 40, that is, an hourglass shape along a side of the core 40. In addition, the core 40 may be disposed between the insulating ribs 19 and be coupled to the bobbin 10.

In the case in which a shape of the insulating ribs 19 are formed corresponding to a shape of the core 40 as described above, they may serve to secure insulation between the coil group 50 wound in the bobbin 10 and the core 40, while simultaneously serving to guide a position of the core 40 when the core 40 is coupled to the bobbin 10.

Therefore, the insulating ribs 19 may protrude by a distance approximately equal to a thickness of the core 40 of a transformer 100. However, the present invention is not limited thereto but may be variously applied. For example, a protrusion distance of the insulating ribs 19 may be set corresponding to a creepage distance between the coil group 50 and the core 40.

Meanwhile, when the bobbin 10 is made of a material having high rigidity and the flange part 15 thus maintains its shape without being bent even in a case in which the insulating ribs 19 are not formed, the insulating ribs 19 may be omitted.

In addition, the bobbin 10 according to the embodiment of the present invention may include at least one penetration groove 17 formed in the upper flange part 15a. In order to see a winding state of the coil group 50 wound in the winding part 12, the penetration groove 17 maybe provided. Therefore, when it is not required to see the winding state of the coil group 50, the penetration groove 17 may be omitted.

This penetration groove 17 may be formed corresponding to positions and shapes of the skip groove 14a and a lead groove 25 to be described below. That is, the skip groove 14a, the lead groove 25, and the penetration groove 17 may be disposed in a straight line in a vertical direction (a Z direction). Therefore, a worker and a user may easily recognize a winding state of the coil group 50 in the respective winding spaces 12a and 12b through the penetration groove 17.

The terminal connection part 20 may be formed in the lower flange part 15b. More specifically, the terminal connection part 20 according to the embodiment may be formed to protrude from the lower flange part 15b in the outer diameter direction thereof in order to secure an insulation distance.

However, the present invention is not limited thereto. The terminal connection part 20 may also be formed to protrude downwardly of the lower flange part 15b.

Meanwhile, referring to the accompanying drawings, since the terminal connection part 20 according to the embodiment is partially extended from the lower flange part 15b, it is difficult to precisely distinguish between the lower flange part 15b and the terminal connection part 20. Therefore, in the terminal connection part 20 according to the embodiment of the present invention, the lower flange part 15b itself may also be perceived as the terminal connection part 20.

External connection terminals 30 to be described below may be connected to the terminal connection part 20 in such a manner that they protrude outwardly of the terminal connection part.

In addition, the terminal connection part 20 according to the embodiment may include a primary terminal connection part 20a and a secondary terminal connection part 20b. Referring to FIG. 1, the embodiment of the present invention describes a case in which the respective primary terminal connection part 20a and the secondary terminal connection part 20b are extended from exposed both ends of the lower flange part 15b by way of example. However, the present invention is not limited thereto and may be variously applied. For example, the primary terminal connection part 20a and the secondary terminal connection part 20b may also be formed on any one end of the lower flange part 15b in such a manner as to be parallel to each other or be formed at positions adjacent to each other.

In addition, the terminal connection part 20 according to the embodiment of the present invention may include a guide groove 22, a lead groove 25, and guide protrusions 27 in order to guide lead wires L of the coil group 50 wound in the winding part 12 to the external connection terminals 30.

The guide groove 22 may be formed in a surface, that is, an upper surface, of the terminal connection part 20. The guide groove 22 may include a plurality of separate grooves respectively corresponding to positions at which the respective external connection terminals 30 are dispose, or the guide groove 22 may be formed as a single integral groove in the accompanying drawings.

In addition, although not shown, the guide groove 22 may have a bottom surface and an edge portion that are inclined at a predetermined angle or curved (for example, chamfered) in order to minimize bending of the lead wires L connected to the external connection terminals 30 at an edge portion of the terminal connection part 20.

The lead groove 25 is used in a case in which the lead wires L of the coil group 50 wound around the winding part 12 lead to a lower portion of the terminal connection part 20, as shown in a dotted line in FIG. 2B. To this end, the lead groove 25 according to the embodiment of the present invention may be formed in such a manner that portions of the terminal connection part 20 and the lower flange part 15b are completely cut away so as to allow the outer surface of the body part 13 to be exposed.

In addition, the lead groove 25 may have a width greater than thicknesses (that is, diameters) of a primary coil 51 and a secondary coil 52.

Particularly, the lead groove 25 according to the embodiment of the present invention is formed at a position corresponding to that of the skip groove 14a of the partition wall 14 described above. More specifically, the lead groove 25 may be formed so as to have the approximately same width as that of the skip groove 14a at a position on which the skip groove 14a projects downwardly.

The lead groove 25 may be formed in pair corresponding to the position of the terminal connection part 20, similar to the skip groove 14a. However, the present invention is not limited thereto. The lead groove 25 may also be formed in plural at various positions as needed.

In addition, the lead groove 25 according to the embodiment of the present invention may include an extension groove 25a formed to have an extended width at a position adjacent to the body part 13.

The extension groove 25a has a width greater than that of the lead groove 25. Here, boundary portions between the lead grove 25 and the extension groove 25a may form a right angel to each other or protrude in a protrusion shape. Therefore, the lead wire L disposed in the extension groove 25a may not be easily transfered to the lead groove 25, and be disposed in a changed direction while supporting a sidewall of the extension groove 25a.

Although the embodiment of the present invention describes a case in which the extension groove 25a is formed to have a width extended from the lead groove 25 in a both directions thereof by way of example, the present invention is not limited thereto and may be variously applied. For example, the extension groove 25a may also be formed to have a width extended only in any one direction, or the extension groove 25a may include a plurality of extension grooves, rather than being a single extension groove may be formed, as needed.

A lower portion of the extension groove 25a, that is, an edge portion connected to a lower surface of the terminal connection part 20 may be formed as an inclined surface or a curved surface through chamfering processing, or the like. Therefore, a phenomenon in which the lead wire L led through the extension groove 25a is bent by the edge portion of the extension groove 25a may be minimized.

The lead groove 25 and the extension groove 25a according to the embodiment were derived in order to minimize leakage inductance generated at the time of driving of the transformer 100.

In the case of the transformer according to the related art, the lead wire of the coil is generally configured such that it may lead to the outside along an inner wall surface of a space in which the coil is wound. Accordingly, the wound coil and the lead wire of the coil may be in contact with each other.

Therefore, the coil is wound to be bent at a portion at which the coil contacts the lead wire thereof and the bending, that is, non-uniform winding, of the coil may cause an increase in leakage inductance.

However, in the transformer 100 according to the embodiment of the present invention, the lead wire L of the coil group 50 may not be disposed in the winding part 12 and may directly lead from a position at which it is wound to an outer portion of the winding part 12, that is, the lower portion of the terminal connection part 20 through the lead groove 25 and the extension groove 25a in a vertical direction.

Therefore, the coil group 50 wound in the winding part 12 may be entirely uniformly wound. Accordingly, the leakage inductance generated due to the bending of the coil group 50 described above, or the like, may be minimized.

A plurality of the guide protrusions 27 may be formed to protrude from one surface of the terminal connection part 20 in parallel with each other. The embodiment of the present invention describes a case in which the plurality of guide protrusions 27 protrude downwardly from the lower surface of the terminal connection part 20 by way of example.

The guide protrusions 27 are to guide the lead wires L of the coil group 50 wound in the winding part 12 such that the lead wires L may be easily disposed from the lower portion of the terminal connection part 20 to the external connection terminals 30, as shown in FIG. 2B. Therefore, the guide protrusions 27 may protrude beyond a diameter of the lead wires L of the coil group 50 so as to guide the coil group 50 disposed therebetween while firmly supporting the coil group 50.

Due to the guide protrusions 27 as described above, the lead wires L of the coil group 50 wound in the winding part 12 may pass through the lead groove 25 and move to the lower portion of the terminal connection part 20, and are then electrically connected to the external connection terminals 30 through spaces between the guide protrusions 27 disposed adjacent to each other. Here, the lead wires L of the coil group 50 may be disposed in a changed direction while supporting sides of the extension groove 25a and the guide protrusions 27 to thereby be connected to the external connection terminals 30.

The terminal connection part 20 according to the embodiment configured as described above was derived in consideration of a case in which the coil group 50 is automatically wound in the bobbin 10.

That is, due to the configuration of the bobbin 10 according to the embodiment of the present invention, winding the coil group 50 in the bobbin 10, skipping the lead wires L of the coil group 50 to the lower portion of the bobbin 10 through the skip groove 25, changing routes of the lead wires L through the guide protrusions 27 to thereby lead the lead wires L in directions in which the external connection terminals 30 are formed and then connecting the lead wires L to the external connection terminals 30, and the like, may be automatically performed through a separate automatic winding device (not shown).

In addition, according to the related art, when a plurality of individual coils are wound in the bobbin, lead wires of the coils led to external connection terminals are disposed to intersect with each other. Therefore, the lead wires may contact each other, thereby causing a short circuit between the coils.

However, in the transformer 100 according to the embodiment, the lead wires L of the coil group 50 may be dispersely disposed on one surface (the guide groove of the terminal connection part) and the other surface (the lower surface on which the guide protrusion is formed) of the lower flange part 15b and be connected to the external connection terminals 30. Therefore, the lead wires L of the coil group 50 are connected to the external connection terminals 30 through more routes as compared to the transformer according to the related art, whereby intersection or contact between a plurality of the lead wires L may be minimized.

The terminal connection part 20 may include a plurality of the external connection terminals 30 connected thereto. The external connection terminal 30 may protrude outwardly from the terminal connection part 20 and have various shapes according to a shape or a structure of the transformer 100 or a structure of a substrate including the transformer 100 mounted thereon.

That is, the external connection terminals 30 according to the embodiment of the present invention are connected to the terminal connection part 20 in such a manner that they protrude from the terminal connection part 20 in the outer diameter direction of the body part 22. However, the present invention is not limited thereto. The external connection terminals 30 may be formed at various positions of the terminal connection part 20 as needed. For example, the external connection terminals 30 may be connected to the terminal connection part 20 in such a manner that they protrude downwardly from the lower surface of the terminal connection part 20.

In addition, the external connection terminals 30 according to the embodiment of the present invention may individually includes an input terminal 30a and an output terminal 30b.

The input terminal 30a is connected to the primary terminal connection part 20a, and is connected to the lead wire L of the primary coil 51 to thereby supply a power to the primary coil 51. In addition, the output terminal 30b is connected to the secondary terminal connection part 20b, and is connected to the lead wire L of the secondary coil 52 to thereby supply an output power set according to a turn ratio between the secondary coil 52 and the primary coil 51 to the outside.

The external connection terminals 30 according to the embodiment of the present invention may include a plurality of (for example, four) input terminals 30a and a plurality of (for example, seven) output terminals 30b. This is derived because the transformer 100 according to the embodiment of the present invention is configured such that the coil group 50 having a plurality of coils is wound in the single winding part 12, as described above. Therefore, in the transformer 100 according to the embodiment of the present invention, the number of external connection terminals 30 is not limited to the above-mentioned number.

In addition, the input terminal 30a and the output terminal 30b may have the same shape or have different shapes as needed. In addition, the external connection terminal 30 according to the embodiment may be variously modified as long as the lead wire L may be easily connected thereto.

For example, as shown in the accompanying drawings, the external connection terminal 30 may have a plurality of protrusions 32 formed therein. These protrusions 32 may include a protrusion 32a serving to divide a connection position of the coil group 50 and a protrusion 32b setting a mounted height of the transformer at the time of mounting of the transformer on the substrate.

The bobbin 10 according to the embodiment of the present invention, configured as described above, may be easily manufactured by an injection molding method. However, a method of forming the bobbin 10 is not limited thereto. In addition, the bobbin 10 according to the embodiment may be made of an insulating resin and be made of a material high heat resistance and high voltage resistance. As a material of the bobbin 10, polyphenylenesulfide (PPS), liquid crystal polyester (LCP), polybutyleneterephthalate (PBT), polyethyleneterephthalate (PET), phenolic resin, and the like, may be used.

The core 40 is partially inserted into the through-hole formed in the inner portion of the bobbin 10 and is electromagnetically coupled to the coil group 50 to thereby form a magnetic path.

The core 40 according to the embodiment is configured in pair. The pair of cores 40 may be partially inserted into the through-hole 11 of the bobbin 10 to thereby be coupled to each other so as to face each other. As the core 40, an ‘EE’ core, an ‘EI’ core, a ‘UU’ core, a ‘UI’ core, or the like, according to a shape thereof, may be used.

In addition, the core 40 according to the embodiment may have an hourglass shape in which a portion thereof contacting the flange part 15 is partially concave according to a shape of the insulating rib 19 of the bobbin 10 described above. However, the present invention is not limited thereto.

The core 40 may be made of Mn—Zn based ferrite having higher permeability, lower loss, higher saturation magnetic flux density, higher stability, and lower production costs, as compared to other materials. However, in the embodiment of the present invention, a shape or a material of the core 40 is not limited.

The coil group 50 may be wound in the winding part 12 of the bobbin 10 and include the primary and secondary coils.

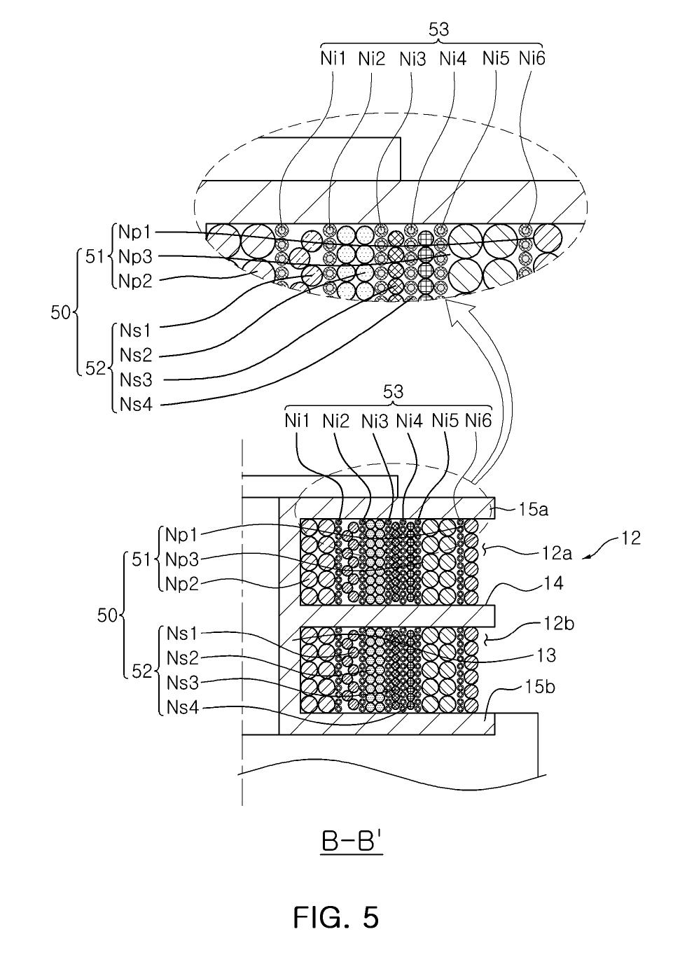

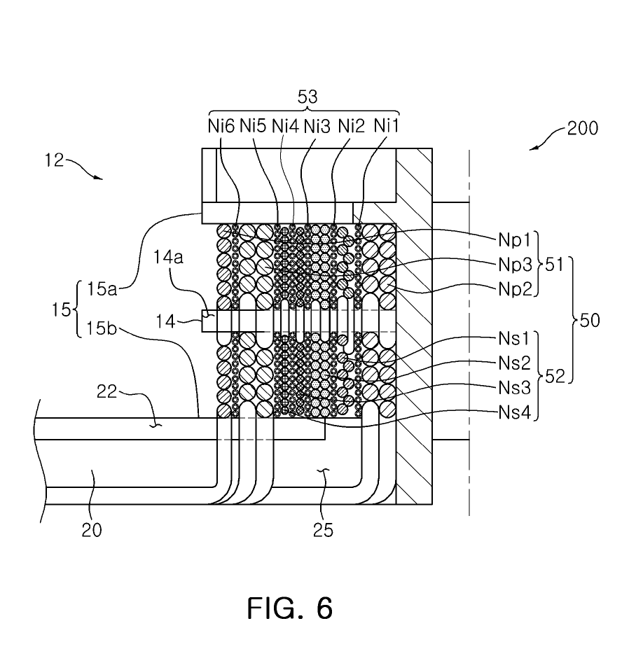

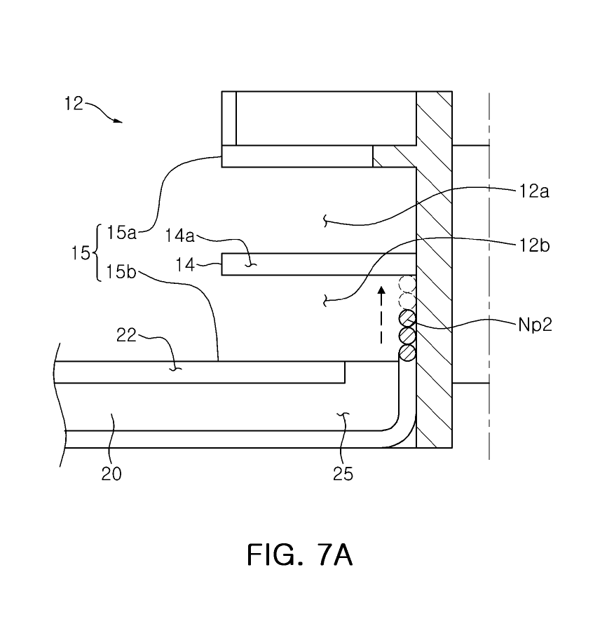

FIG. 5 is a cross-sectional view taken along line B-B′ of FIG. 3. FIG. 6 is a partial cross-sectional view taken along line A-A′ of FIG. 3. FIGS. 5 and 6 show a cross section in a state in which the coil group 50 is wound in the bobbin 10.

Referring to FIGS. 5 and 6, the coil group 50 may include a primary coil 52, a secondary coil 52, and an insulating wire 53. The primary coil 51 may include a plurality of coils Np1, Np2, and Np3 that are electrically insulated from each other. The embodiment describes a case in which the primary coil 51 is formed by winding each of three independent coils Np1, Np2, and Np3 in the single winding part 12 by way of example.

Therefore, in the primary coil 51 according to the present embodiment, a total of six lead wires L lead to thereby be connected to the external connection terminals 30. Meanwhile, for convenience of description, only a few lead wires L are representatively shown in FIG. 1.

Referring to FIG. 5, a case in which the primary coil 51 according to the embodiment of the present invention includes the coils Np1, Np2, and Np3 having a similar thickness is shown. However, the present invention is not limited thereto. Each of the coils Np1, Np2, and Np3 configuring the primary coil 51 may also have different thicknesses as needed. In addition, the respective coils Np1, Np2, and Np3 may have the same turns or have different turns as needed.

Further, in the transformer 100 according to the present invention, when a voltage is applied to at least any one (for example, Np2 or Np3) of the plurality of primary coils Np1, Np2, and Np3, a voltage may also be drawn in the other primary coil (for example Np1) by electromagnetic induction. Therefore, the transformer 100 may also be used in a display device to be described below.

As described above, in the transformer 100 according to the present embodiment, the primary coil includes the plurality of coils Np1, Np2, and Np3, such that various voltages may be applied and be drawn through the secondary coil 52b correspondingly.

Meanwhile, the primary coil 51 according to the embodiment is not limited to the three independent coils Np1, Np2, and Np3 as in the case according to the present embodiment but may include various numbers of coils as needed.

The secondary coil 52 is wound in the winding part 12, similar to the primary coil 51. Particularly, the secondary coil 52 according to the embodiment is wound while being stacked in a sandwich form between the plurality of coils Np1, Np2, and Np3 of the primary coil 51.

The secondary coil 52 may be formed by winding a plurality of coils electrically insulated from each other, similar to the primary coil 51.

More specifically, the embodiment describes a case in which the secondary coil 52 includes four independent coils Ns1, Ns2, Ns3, and Ns4 electrically insulated from each other by way of example. Therefore, in the secondary coil 52 according to the embodiment, a total of eight lead wires L may led to thereby be connected to the external connection terminals 30.

In addition, as the respective coils Ns1, Ns2, Ns3, and Ns4 of the secondary coil 52, coils having the same thickness or coils having different thicknesses may be selectively used. The respective coils Ns1, Ns2, Ns3, and Ns4 may also have the same turns or have different turns as needed.

The respective wires Ni1, Ni2, Ni3, Ni4, Ni5, and Ni6 of the insulating wire 53 maybe wound between the respective coils of the primary and secondary coils 51 and 52 to thereby insulate between the respective coils. That is, due to a safety standard such as UL, CE, and the like, the insulation generally needs to be made between the primary coils Np1, Np2, and Np3, between the secondary coils Ns1, Ns2, Ns3, and Ns4, or between the primary coils Np1, Np2, and Np3 and the secondary coils Ns1, Ns2, Ns3, and Ns4 by an insulating tape, or the like. However, the above-mentioned insulating tape is manually wound directly by an operator, such that a working time may be delayed and manufacturing costs increase. The insulating wire 53, which is a wire made of an insulating material such as nylon, may be automatically wound, similar to the primary and secondary coils 51 and 52, such that a working time and manufacturing costs may be reduced.

Particularly, the transformer 100 according to the present embodiment also has characteristics in a structure in which the coil group 50 is wound. Hereinafter, a detailed description thereof will be provided with reference to the accompanying drawings.

As described above, the primary coil 51 according to the present embodiment includes three independent coils (hereinafter, referred to as Np1, Np2, and Np3). In addition, the secondary coil 52 includes four independent coils (hereinafter, referred to as Ns1, Ns2, Ns3, and Ns4). In addition, the insulating wire 53 includes six independent wires Ni1, Ni2, Ni3, Ni4, Ni5, and Ni6 insulating between the primary coils Np1, Np2, and Np3, between the secondary coils Ns1, Ns2, Ns3, and Ns4, or between the primary coils Np1, Np2, and Np3 and the secondary coils Ns1, Ns2, Ns3, and Ns4.

These respective coil groups 50 may be wound on the outer peripheral surface of the body part 13 such that they are disposed thereon in various orders and forms.

In the case of the embodiment, Np2 of the primary coils Np1, Np2, and Np3 is wound on the outer peripheral surface of the body part 13, and Np3 and Np1 thereof are sequentially wound at an outermost position of the winding space 12a and 12b in a state in which they are spaced apart from Np2 by a predetermined interval. In addition, Ns1, Ns2, Ns3, and Ns 4, which are the secondary coils 52, are sequentially disposed between Np2 and Np3. Here, the insulating wire Ni1 is wound between Np2 and Ns1 and the insulating wire Ni2 is wound between Ns1 and Ns2. The insulating wires Ni3, Ni4, Ni5, and Ni6 may be wound between each of Ns3, Ns4, Np3, and Np1 in this scheme.

Here, Np2 and Np3 of the primary coils Np1, Np2, and Np3 may be configured such that they may be made of the same material and have the same turns and each of lead wires L thereof is connected the same external connection terminal 30.

Further, in the secondary coil 52, a coil of which a lead wire L is connected to an external connection terminal 30 disposed at an outermost position of the terminal connection part 20 maybe disposed at an innermost position thereof. That is, in the case of FIG. 5, a lead wire L of Ns1 may be connected to an external connection terminal 30 disposed at the outermost position among the external connection terminals 30.

However, the present invention is not limited thereto but may be variously applied. For example, the disposition order of the respective individual coils Np1 to Ns4 maybe set based on voltages drawn in the respective individual coils Np1 to Ns4 or turns of the respective individual coils Np1 to Ns4.

The respective coils Np1 to Ns4 according to the present embodiment are wound such that they are disposed in the spaces 12a and 12b by the partition wall 14 in a uniformly distributed scheme.

More specifically, the respective coils Np1 to Ns4 are wound to have the same turns in each of upper and lower winding spaces 12a and 12b, and are disposed to form the vertically same layer as shown in FIG. 5. Therefore, the respective coils Np1 to Ns4 wound in the upper and lower winding spaces 12a and 12b are wound to have the same shape to each other.

This configuration is to minimize the generation of the leakage inductance in the transformer 100 according to a winding state of the coil group 50.

Generally, when the coils are wound in the winding part of the bobbin, they are not entirely wound uniformly while being relatively more wound in one side or be wound while being non-uniformly disposed. In this case, the leakage inductance in the transformer may increase. In addition, this defect may be intensified as the space of the winding part becomes large.

Therefore, in the transformer 100 according to the embodiment, the winding part 12 is partitioned into the several spaces 12a and 12b by the partition wall 14 in order to minimize the leakage inductance generated for the above-mentioned reason. In addition, the coil group 50 is uniformly wound in the respective partitioned spaces 12a and 12b.

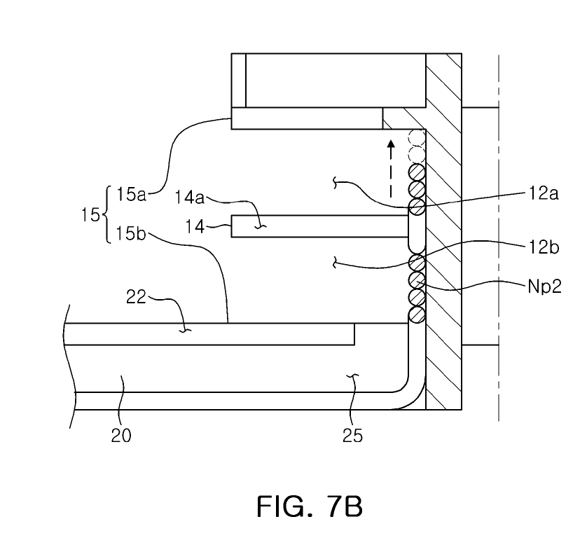

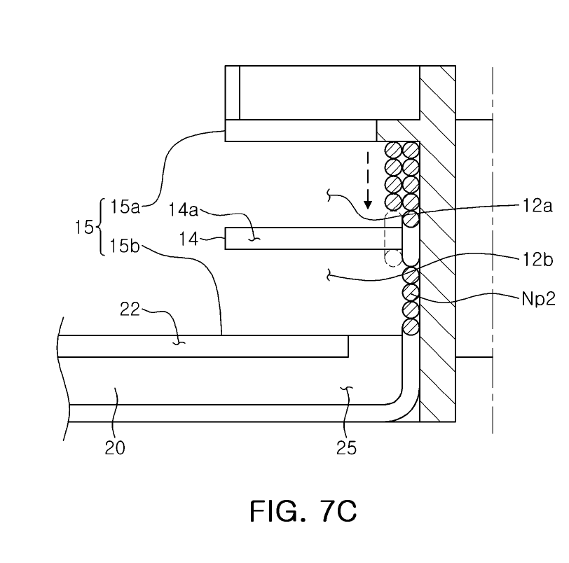

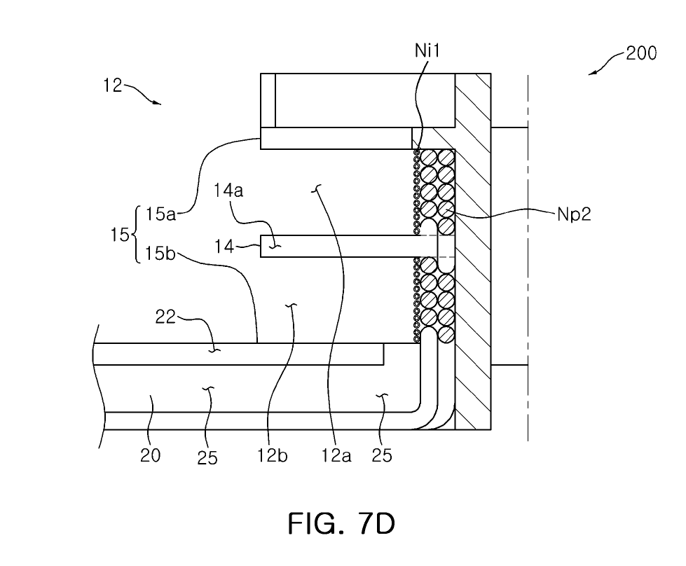

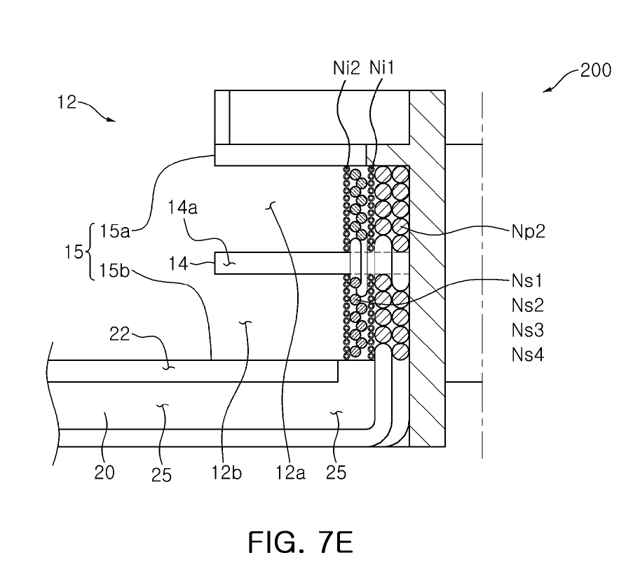

FIGS. 7A through 7E are views describing a method of winding coils shown in FIG. 5. Hereinafter, a method of winding coils of the transformer 100 according to the embodiment will be described with reference to FIGS. 7A through 7E.

First referring to FIG. 7A, a specific coil (for example, Np2) is first wound while forming a single layer in the lower winding space 12b. Here, the coil Np2 is the primary coil, such that it leads from the lower surface of the primary terminal connection part 20a into the lower winding space 12b through the lead groove 25.

The coil Np2 led into the lower winding space 12b starts to be wound in a lower end of the lower winding space 12b (that is, an inner surface of the lower flange part) and is then sequentially wound toward an upper portion of the bobbin 10.

Then, as shown in FIG. 7B, the coil Np2 is skipped to the upper winding space 12a through the skip groove 14a, and is also wound in the upper winding space 12a while forming a single layer. As in the lower winding space 12b, the coil Np2 is sequentially wound toward the upper portion of the bobbin 10.

After the coil Np2 is wound in the upper and lower winding spaces 12a and 12b while forming the single layer through the above-mentioned process, the coil Np2 is again wound and stacked on the coil Np2 wound in FIG. 7B while forming a new layer, as shown in FIG. 7C. Then, the coil Np2 is also uniformly wound in the lower winding space 12b, corresponding to the above-mentioned process, as shown in FIG. 7D. In addition, the insulating wire Ni1 may be wound in order to insulate between the coil Np2 and a subsequently wound coil. Ni1 may be wound through the same method as the winding method of the coil Np2.

Next, another coil (for example, Ns1) may be wound and stacked on the coil Np2 through the same process as the above-mentioned process while forming a new layer, as shown in FIG. 7E. Here, the coil Ns1 is the secondary coil, such that it is wound while being led from a lower surface of the secondary terminal connection part 20b into the lower winding space 12b through the skip groove. Likewise, the insulating wire Ni2 may be wound in order to insulate between the coil Ns1 and a subsequently wound coil. The coil Ni2 may be wound through the same method as the winding method of the coil Ns1.

When winding of remaining coils and insulating wires (for example, in the order of Ns2, Ni3, Ns3, Ni4, Ns4, Ni5, Np3, Ni6, and Np1) is completed through the above-mentioned process, the coils are wounded in the form shown in FIG. 5.

Here, as described above, each of the coils Np1 to Ns4 wound in the upper and lower winding spaces 12a and 12b is set to have the same turns. For example, when the coil Ns1 has the total turns of 18, it is wound nine times in the upper winding space 12a and nine times in the lower winding space 12b, such that it is disposed in a uniformly distributed scheme.

Meanwhile, referring to the accompanying drawings, in the case of the embodiment, the coil Ns1 is not densely wound and is wound eight times in a first layer and ten times in a second layer. Therefore, since both of two lead wires (not shown) of the coil Ns1 are directed to a lower portion of the winding part 12, they may easily lead to the terminal connection part 20 to thereby be connected to the external connection terminals 30.

Although the accompanying drawings show the above-mentioned winding structure only with respect to the coil Ns1 for convenience of description, the present invention is not limited thereto. The above-mentioned winding structure may also be easily applied to other coils.

As described above, in the case of the transformer 100 according to the embodiment, even though turns or a thickness of the coil are smaller than widths of the winding spaces 12a and 12b, such that the coil (for example, Ns1) may not be densely wound in the winding part 12, the winding part 12 is partitioned into a plurality of the spaces 12a and 12b, such that the coil (for example, Ns1) may be wound so as to be disposed at the same position within the respective partitioned spaces 12a and 12b in a distributed scheme without being relatively more wound in any one side.

In the transformer 100 according to the present embodiment, the respective independent coils Np1 to Ns4 are disposed in the upper and lower winding spaces 12a and 12b in a uniformly distributed scheme according to the winding method and the structure of the bobbin 10 described above. Therefore, in the entire winding part 12, a phenomenon in which the coils Np1 to Ns4 are relatively more wound in any one side or are non-uniformly wound while being spaced apart from each other maybe prevented. As a result, the leakage inductance generated due to the non-uniform winding of the coils Np1 to Ns4 may be minimized.

Meanwhile, as the coils Np1 to Ns4 according to the present embodiment, a general insulated coil (for example, a polyurethane wire), or the like, and a twisted pair wire form of coil formed by twisting several strands of wires (for example, a Litz wire, or the like) may be used. In addition, a multi-insulated coil having a high insulation property (for example, a triple insulated wire (TIW)) maybe additionally used in order to minimize an insulation distance between the coils. That is, a kind of the coil may be selected as needed.

Again referring to FIG. 5, in the transformer 100 according to the present embodiment, the primary coils 51 are, for example, the multi-insulated coils. In this case, the multi-insulated coils, which are the primary coils 51, are disposed at each of the innermost and outmost positions of the coils 50 wound in the winding part 12 while being stacked therein.

When the multi-insulated coils are disposed at each of the innermost and outmost positions of the coils 50 wound as described above, the multi-insulated coils 51, which are the primary coils, serve as an insulating layer between the secondary coils 52, which are general insulated coils, and the outside. Therefore, the insulation property between the outside and the secondary coil 52 may be more easily secured.

Meanwhile, although the embodiment of the present invention describes a case in which the multi-insulated coils, which are the primary coils 51, are disposed at both of the innermost and outmost positions of the coils 50 by way of example, the present invention is not limited thereto. That is, the multi-insulated coils may also be selectively disposed only at any one of the innermost and outmost positions of the coils 50 as needed.

In addition, the coils may be disposed in various forms as needed as in an embodiment to be described below.

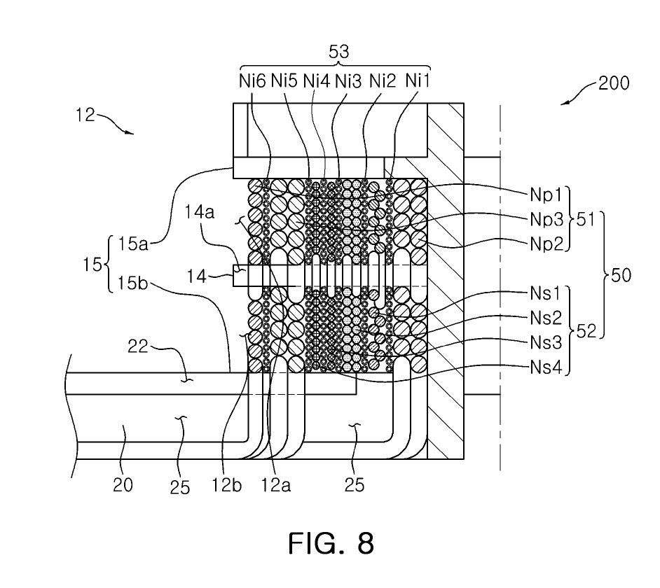

FIG. 8 is a perspective view showing a transformer according to another embodiment of the present invention. FIG. 8 shows a cross section taken along line A-A′ of FIG. 3, and also shows a cross section in a state in which a coil is wound in a bobbin.

Referring to FIG. 8, a coil according to the present embodiment includes a primary coil 51 and a secondary coil 52, similar to the above-mentioned embodiment.

That is, the primary coil 51 includes three independent coils (hereinafter, referred to as Np1, Np2, and Np3), the secondary coil 52 includes four independent coils (hereinafter, referred to as Ns1, Ns2, N3s, and Ns4), an insulating wire 53 includes six independent wires (hereinafter, referred to as Ni1, Ni2, Ni3, Ni4, Ni5, and Ni6). Here, the secondary coil 52 may be configured such that a potential between Ns2 and Ns3 may be largest. In this case, as the secondary coil 52, the multi-insulated coil is used, whereby insulation may be further secured.

Meanwhile, the embodiment of the present invention describes a case in which only the primary coils 51 are the multi-insulated wires by way of example, the present invention is not limited thereto. That is, even though the secondary coils 52 rather than the primary coils 51 are the multi-insulated wires, the same effect may be obtained.

In addition, although the present embodiment describes a case in which the secondary coils 52 are disposed between the primary coils 51, the present invention is not limited thereto. The primary coils 51 may also be appropriately disposed between the secondary coils 52 as needed.

The transformer according to the embodiment of the present invention configured as described above is not limited to the above-mentioned embodiments but may be variously applied.

A transformer to be described below has a similar shape to that of the transformer according to the above-mentioned embodiment and is mainly different therefrom in a structure of a bobbin. Therefore, a detailed description of the same configuration as that of the transformer according to the above-mentioned embodiment will be omitted, and a structure of a bobbin will be mainly described.

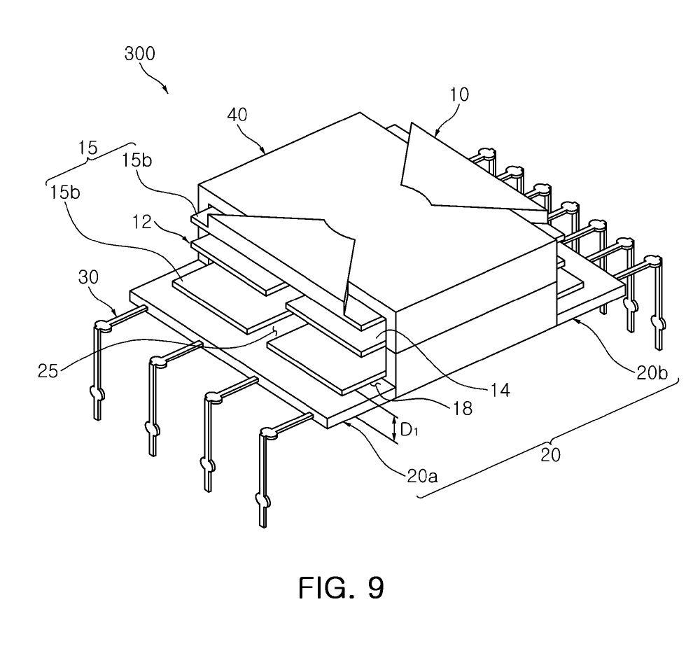

FIG. 9 is a perspective view showing a transformer according to another embodiment of the present invention; and

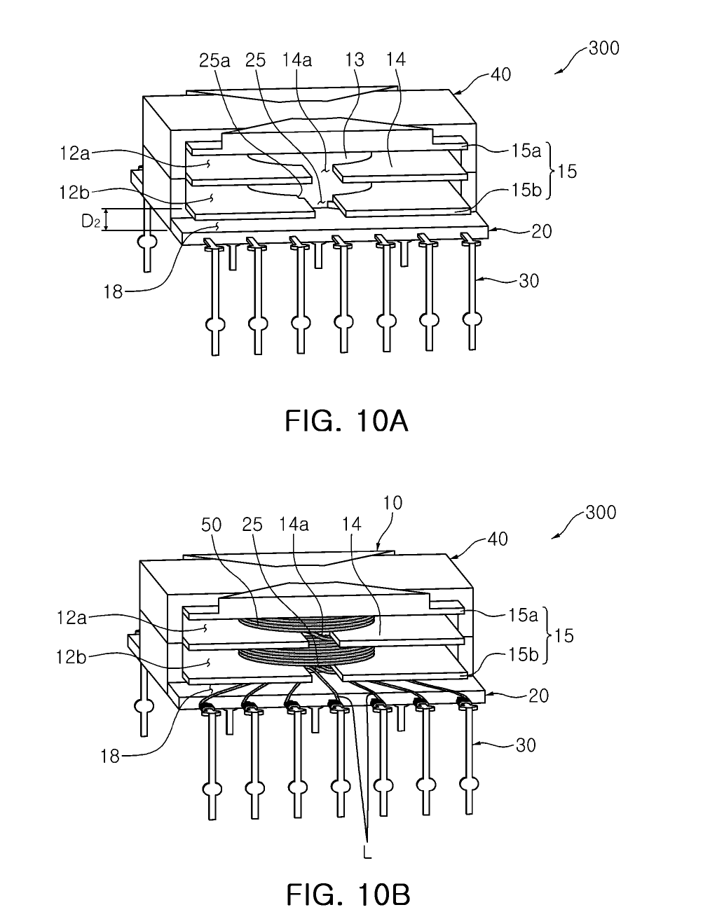

FIGS. 10A and 10B are perspective views showing a side of the transformer shown in FIG. 9. Here, FIGS. 9 and 10A show a transformer in a state in which a coil is omitted, and FIG. 10B shows a transformer in a state in which a coil is wound.

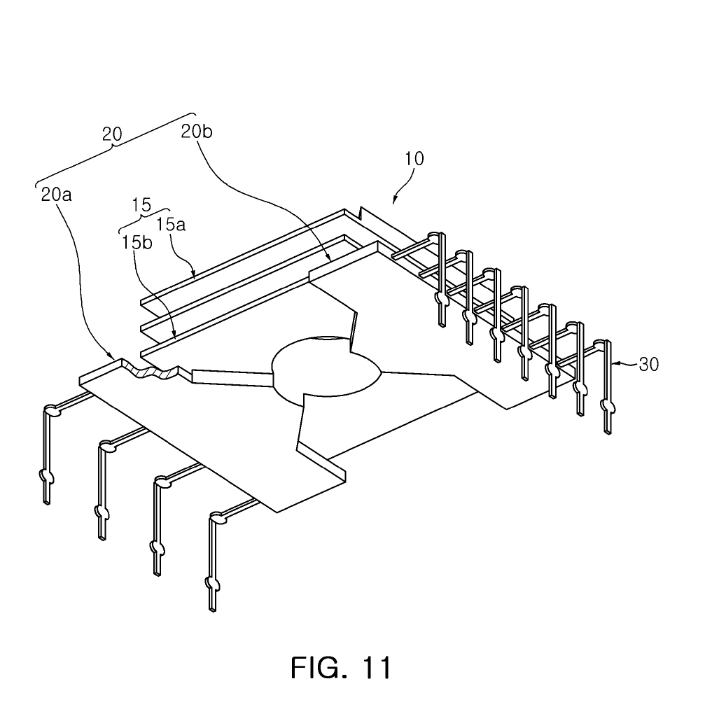

FIG. 11 is a perspective view schematically showing a lower surface of a bobbin shown in FIG. 9.

Referring to FIGS. 9 through 11, a transformer 300 according to the present embodiment includes the coil group 50, the bobbin 10, and the core 40.

The coil group 50 may be configured to be the same as that of the above-mentioned embodiment. Therefore, a detailed description thereof will be omitted.

The core 40 is partially inserted into the through-hole 11 formed in an inner portion of the bobbin 10 and is electromagnetically coupled to the coil group 50 to thereby form a magnetic path.

The core 40 according to the embodiment is configured in pair. The pair of cores 40 may be partially inserted into the through-hole 11 of the bobbin 10 to thereby be coupled to each other so as to face each other.

In addition, the core 40 according to the embodiment may have an hourglass shape in which a portion thereof (hereinafter, a lower surface) disposed at a lower portion of the transformer 300 is partially concave. This shape, corresponding to a shape of a terminal connection part 20 of a bobbin 10 to be described below, will be described in detail in a description of the terminal connection part 20.

The bobbin 10 according to the embodiment includes the body part 13, the winding part 12 including the flange part 15 extended from both ends of the body part 13 in an outer diameter direction thereof, and the terminal connection part 20 formed under the winding part 12.

The winding part 12 is configured to be similar to that of the above-mentioned embodiment. That is, the coil group 50 is wound around an outer peripheral surface of the body part 13, and a space is partitioned by a partition wall 14. The partition wall 14 may include the skip groove 14a formed therein, the skip groove 14a being described in the above-mentioned.

In addition, the body part 13 includes upper and low flange parts 15a and 15b formed on both ends thereof. Further, the lower flange part 15b may include the lead groove 25 and the extension groove 25a formed therein, the lead groove 25 and the extension groove 25a being described in the above-mentioned embodiment.

Meanwhile, in the transformer 300 according to the present embodiment, the lead wires L of the coil are disposed at a lower space 18 (hereinafter, referred to as a lead wire skip part) of the lower flange part 15b. Therefore, the lower flange part 15b may protrude outwardly to be longer than the upper flange part 15a in order to secure insulation (for example, a creepage distance, or the like) between the lead wires L and the coils 50 wound in the winding part. That is, the lower flange part 15b may have an increased area in a direction in which the lead groove 25 is formed to thereby have an area wider than that of the upper flange part 15a.

The terminal connection part 20 is formed under the lower flange part 15b so as to be spaced apart therefrom by a predetermined interval. More specifically, the terminal connection part 20 may be formed to have a shape in which it is extended downwardly from the lower flange part 15b by a predetermined distance and protrudes from and protrudes from the extended distal end in an outer diameter direction of the body part 13 to be parallel to the lower flange part 15b.

This terminal connection part 20 may be formed in pair 20a and 20b under both ends of the lower flange part 15b exposed to the outside of the core 40. These two terminal connection parts 20a and 20b may include primary and secondary coils each connected thereto. However, the present invention is not limited thereto but may be variously applied. For example, only a single terminal connection part 20 may also be formed on any one side and both of the primary and secondary coils 51 and 52 may be connected to the single terminal connection part 20 as needed.

In addition, a space between two terminal connection parts 20a and 20b is used as a space into which a portion of the core 40 (that is, a lower surface of the core) is inserted. Therefore, the space between terminal connection parts 20a and 20b may have a shape corresponding to an outer shape of the lower surface of the core 40.

As described above, the lower surface of the core 40 according to the present embodiment has a partially convex shape. Therefore, the terminal connection part 20 is extended downwardly from the lower flange part 15b along a shape of the core 40. Accordingly, a space having a predetermined size between the lower flange part 15b and the terminal connection part 20 may be secured.

The space secured between the lower flange part 15b and the terminal connection part 20 is used as the lead wire skip part 18, which is a space at which the lead wire L of the coil group 50 is disposed.

Therefore, the lead wire L of the coil group 50 wound in the winding part 12 leads to a lower portion of the lower flange part 15b through the lead groove 25 of the lower flange part 15b to thereby be disposed at the lead wire skip part 18. In addition, the lead wire L may be disposed in a changed direction in the lead wire skip part 18 to thereby be connected to the external connection terminal 30.

Here, the lead wire L may be inserted into the extension groove 25a formed in the lower flange part 15b and be then disposed in a changed direction while supporting a sidewall of the extension groove 25a. However, the present invention is not limited thereto. That is, a separate guide protrusion (not shown) maybe formed in the lead wire skip part 18 in order to dispose the lead wire L in a changed direction.

The guide protrusion may protrude from an upper surface of the terminal connection part 20 in a protrusion shape, which is a shape similar to that of the guide protrusion 27 (See FIG. 2B) of the above-mentioned embodiment. However, the present invention is not limited thereto but may be variously applied. For example, the guide protrusion may also protrude from the lower surface of the lower flange part 15b.

In this case, the lead wire L within the lead wire skip part 18 may be disposed in a changed direction while supporting a side of the guide protrusion.

In the transformer 300 according to the present embodiment configured as described above, the lead wire L of the coil group 50 is not disposed in the winding part 12 but directly leads from a position at which it is wound to the lead wire skip part 18 through the lead groove 25 and the extension groove 25a in a vertical direction and is then connected to the external connection terminal 30.

Therefore, the coil group 50 wound in the winding part 12 may be entirely uniformly wound. Accordingly, the leakage inductance generated due to the bending of the coil group 50, or the like, may be minimized.

In addition, a separate lead wire skip part 18 is provided, whereby a plurality of lead wires L may be more easily disposed. In addition, since the lead wires L are disposed within the lead wire skip part 18, exposure of the lead wires L to the outside maybe minimized, such that damages of the lead wires L due to the physical contact between the lead wires L and the outside may be prevented.

Meanwhile, in the transformer 300 according to the present invention, a spaced distance between the terminal connection part 20 and the lower flange part 15b corresponds to a thickness of the core 40. More specifically, a vertical distance D1 (See FIG. 9) from the lower surface of the lower flange part 15b to the lower surface of the terminal connection part 20 may be the same as or smaller than a thickness D2 (See FIG. 10) of the lower surface of the core 40. Therefore, the lower surface of the terminal connection part 20 is disposed on the same plane as the lower surface of the core 40 or is disposed at a position higher than the lower surface of the core 40.

Due to this configuration, even though the transformer 300 according to the present embodiment further includes the lead wire skip part 18 as compared to the transformer 100 (See FIG. 1) according to the above-mentioned embodiment, it may have the same thickness as that of the transformer 100 in the entire size of the transformer.

Meanwhile, the present invention is not limited to the above-mentioned configuration but maybe variously applied. For example, the lower surface of the terminal connection part 20 may also be disposed at a position lower than the lower surface of the core 40 as needed.

In addition, although the present embodiment describes a case in which the terminal connection part 20 and the winding part 12 are formed integrally with each other by way of example, the present invention is not limited thereto but may be variously applied. For example, the winding part 12 and the terminal connection part 20 may be individually manufactured and be then coupled to each other to thereby form an integral bobbin.

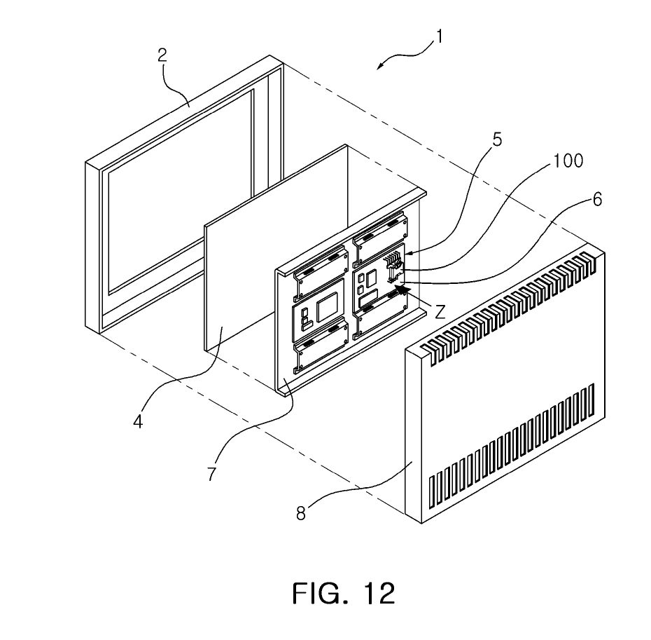

FIG. 12 is an exploded perspective view schematically showing a flat panel display device according to an embodiment of the present invention.

First referring to FIG. 12, a flat panel display device 1 according to an embodiment of the present invention may include a display panel 4, a switching mode power supply (SMPS) 5 having the transformer 100 mounted therein, and covers 2 and 8.

The covers 2 and 8 may include a front cover 2 and a back cover 8 and may be coupled to each other to thereby form a space therebetween.

The display panel 4 is disposed in an internal space formed by the covers 2 and 8. As the display panel, various flat panel display panels such as a liquid crystal display (LCD), a plasma display panel (PDP), an organic light emitting diode (OLED), and the like, may be used.

The SMPS 5 provides a power to the display panel 4. The SMPS 5 may be formed by mounting a plurality of electronic components on a printed circuit board 6 thereof and particularly, may include at least one of the transformers 100, 200, and 300 according to the above-mentioned embodiments mounted therein. The present embodiment describes a case in which the SMPS includes the transformer 100 of FIG. 1 by way of example.

The SMPS 5 may be fixed to a chassis 7, and be disposed and fixed in the internal space formed by the covers 2 and 8 together with the display panel 4.

Here, in the transformer 100 mounted in the SMPS 5, the coil group 50 (See FIG. 1) is wound in a direction that is parallel to the printed circuit board 6. In addition, when being viewed from a plane of the printed circuit board 6 (a Z direction), the coil group 50 is wound clockwise or counterclockwise. Therefore, a portion (an upper surface) of the core 40 forms a magnetic path while being parallel to the back cover 8.

Therefore, in the transformer 100 according to the present embodiment, a magnetic path of most of magnetic flux formed between the back cover 8 and the transformer 100 among a magnetic field generated by the coil group 50 is formed in the core 40, whereby the generation of leakage magnetic flux between the back cover 8 and the transformer 100 may be minimized.

Therefore, even though the transformer 100 according to the present embodiment does not includes a separate shielding device (for example, a shielding shield, or the like) on an outer portion thereof, it may prevent vibration of the back cover 8 due to interference between the leakage magnetic flux of the transformer 100 and the back cover 8 made of a metal material.

Therefore, even though the transformer 100 is mounted in a thin electronic device such as the flat panel display device 1, such that the back cover 8 and the transformer 100 have a significantly narrow space therebetween, the generation of noise due to vibrations of the back cover 8 may be prevented.

As set forth above, with the transformer according to the embodiments of the present invention, the insulating wire may be wound in order to more easily secure the insulation property between the primary coils, between the secondary coils, or between the primary and secondary coils. The above-mentioned insulating wire may be automatically wound, whereby a working time and manufacturing costs may be reduced. That is, in the case according to the related art in which the insulating tape is used, a method of winding the coil in the bobbin, manually attaching the insulating tape thereto, and then again winding the coil is repeatedly performed, which causes an increase in the working time and manufacturing cost. Therefore, instead of the insulating tape, the insulating wire that may be automatically wound is used, whereby the working time and manufacturing costs may be reduced.

In addition, in the transformer according to the embodiments of the present invention, the winding space of the bobbin is uniformly partitioned into a plurality of spaces, and the respective individual coils are wound in the partitioned spaces in a uniformly distributed scheme. In addition, the respective individual coils are wound in a shape in which they are stacked.

Therefore, a phenomenon in which the individual coils are relatively more wound in any one side or are non-uniformly wound while being spaced apart from each other within the winding part may be prevented. As a result, the leakage inductance generated due to the non-uniform winding of the coils may be minimized

Further, in the transformer according to the embodiments of the present invention, the coils maybe connected to the external connection terminals through the lower surface of the terminal connection part as well as the upper surface thereof. Therefore, the lead wires of the coil maybe connected to the external connection terminals through more routes, whereby the generation of a short circuit due to the contact between the lead wires may be prevented.

In addition, in the transformer according to the embodiments of the present invention, the lead wires of the coils are not disposed within the winding part but directly lead to the outside of the winding part through the lead groove.

Therefore, the coils wound in the winding part maybe uniformly wound, whereby the leakage inductance generated due to the bending of the coil, or the like, may be minimized.

Further, in the transformer according to the embodiments of the present invention, when the lead wire skip part is formed in the bobbin, exposure of the lead wires to the outside maybe minimized, whereby the damages of the lead wires due to the physical contact between the lead wire and the outside may be prevented.

In addition, when the transformer according to the embodiments of the present invention is mounted on the substrate, the coil of the transformer is maintained in a state in which it is wound parallel to the substrate. When the coil is wound parallel to the substrate as described above, interference between the leakage magnetic flux generated from the transformer and the outside may be minimized.

Therefore, even though the transformer is mounted in the thin display device, the generation of the interference between the leakage magnetic flux generated from the transformer and the back cover of the display device may be minimized. Therefore, the noise generation in the display device by the transformer may be prevented. Therefore, the transformer may also be easily used in a thin display device.

The transformer according to the embodiments of the present invention as described above is not limited to the above-mentioned exemplary embodiments but may be variously applied. For example, the above mentioned embodiments describe a case in which the flange part and the partition wall of the bobbin have a rectangular shape by way of example. However, the present invention is not limited thereto. That is, the flange part and the partition wall of the bobbin may also have various shapes such as a circular shape, an ellipsoidal shape, or the like, as needed.

In addition, although the above-mentioned embodiments describe a case in which the body part of the bobbin has a circular cross section by way of example, the present invention is not limited thereto but may be variously applied. For example, the body part of the bobbin may also have an ellipsoidal cross section or a polygonal cross section.

Further, although the above-mentioned embodiments describe a case in which the terminal connection part is formed in the lower flange part or under the lower flange part by way of example, the present invention is not limited thereto but maybe variously applied. For example, the terminal connection part may also be formed in the upper flange part or over the upper flange part.

Furthermore, although the above-mentioned embodiments describe a case in which the guide protrusions protrude from the lower surface of the terminal connection part and the guide grooves are formed in the upper surface of the terminal connection part by way of example, the present invention is not limited thereto but may be variously applied as needed. For example, the guide protrusions may be formed on the upper surface of the terminal connection part and the guide grooves maybe formed in the lower surface of the terminal connection part.

Moreover, although the above-mentioned embodiments describe the insulating type switching transformer by way of example, the present invention is not limited but maybe widely applied to any transformer, coil component, and electronic device including a plurality of coil wound therein.

While the present invention has been shown and described in connection with the embodiments, it will be apparent to those skilled in the art that modifications and variations can be made without departing from the spirit and scope of the invention as defined by the appended claims.

What is claimed is:

1. A transformer comprising:
a bobbin including at least one partition wall formed on an outer peripheral surface of a body part having a pipe;
a coil group including a plurality of coils wound while being stacked on the body part and at least one insulating wire wound between the plurality of coils; and
a core electromagnetically coupled to the coils to thereby form a magnetic path,
wherein the plurality of coils are individually wound so as to be uniformly disposed in a plurality of spaces partitioned by the at least one partition wall.

2. The transformer of claim 1, wherein the at least one partition wall includes at least one skip groove formed therein, and the plurality of coils are wound while skipping the at least one partition wall via the skip groove.

3. The transformer of claim 2, wherein the at least one skip groove is formed by cutting away a portion of the at least one partition wall such that the outer peripheral surface of the body part is exposed.

4. The transformer of claim 1, wherein all of the plurality of partitioned spaces of the bobbin are formed to have the same size.

5. The transformer of claim 1, wherein the bobbin includes a flange part extended from both ends thereof in an outer diameter direction of the body part.

6. The transformer of claim 5, wherein the flange part includes at least one insulating rib protruding from an outer surface thereof in order to reinforce rigidity thereof.

7. The transformer of claim 6, wherein the at least one insulating rib protrudes corresponding to a shape of the core and at a height corresponding to a creepage distance between the core and the plurality of coils.

8. The transformer of claim 1, wherein the bobbin includes a terminal connection part extended from either end of the body part in an outer diameter direction of the body part, and including a plurality of external connection terminals connected to a distal end thereof.

9. The transformer of claim 8, wherein the terminal connection part includes at least one lead groove formed therein, and at least one of the plurality of coils has a lead wire leading to the outside of the bobbin through the at least one lead groove.

10. The transformer of claim 9, wherein the at least one lead groove is formed by cutting away a portion of the terminal connection part such that the outer peripheral surface of the body part is exposed.

11. The transformer of claim 10, wherein the terminal connection part includes an extension groove formed in such a manner that the at least one lead groove has an extended width at a portion thereof adjacent to the body part.

12. The transformer of claim 11, wherein the plurality of coils have lead wires disposed in an altered direction while supporting a sidewall of the extension groove.

13. The transformer of claim 11, wherein the extension groove has a chamfered edge portion.

14. The transformer of claim 8, wherein the terminal connection part includes at least one guide protrusion protruding from at least one surface thereof, the at least one guide protrusion guiding lead wires of the plurality of coils to the plurality of external connection terminals.

15. The transformer of claim 8, wherein the terminal connection part includes at least one guide groove formed in at least one surface thereof, the at least one guide groove guiding lead wires of the plurality of coils to the plurality of external connection terminals.

16. The transformer of claim 1, wherein the plurality of coils include a plurality of primary coils and a plurality of secondary coils.

17. The transformer of claim 16, wherein the plurality of coils are wound while being stacked such that the plurality of secondary coils are interposed between the plurality of primary coils, and the at least one insulating wire is wound between the plurality of primary coils and between the plurality of secondary coils.

18. The transformer of claim 17, wherein the plurality of primary coils are multi-insulated coils.

19. The transformer of claim 1, wherein at least one of the plurality of coils is a multi-insulated coil.

20. The transformer of claim 19, wherein the multi-insulated coil is disposed at at least one of an innermost position or an outermost position of the plurality of the coils wound while being stacked in a winding part.

21. A transformer comprising:
a bobbin including a plurality of partitioned spaces; and
a coil group including a plurality of coils wound while being stacked in the plurality of partitioned spaces and at least one insulating wire wound between the plurality of coils;
wherein the plurality of coils are individually wound so as to be uniformly disposed in the plurality of partitioned spaces.

22. A display device comprising:
a switching mode power supply including at least one transformer of claim 1 mounted on a substrate thereof;
a display panel receiving a power from the switching mode power supply; and
covers protecting the display panel and the switching mode power supply.

23. The display device of claim 22, wherein the coil group of the transformer is wound so as to be parallel to the substrate of the switching mode power supply.
